(19) United States
(12) Patent Application Publication
(10) Pub. No.: US 2005/0261614 A1
(43) Pub. Date: Nov. 24, 2005

(54) Therapeutic instrument

(76) Inventor: Wakae Katumata, Tokyo (JP)

Correspondence Address: PAUL A. FATTIBENE;FATTIBENE & FATTIBENE, 2480 POST ROAD, SOUTHPORT, CT, 06890, US

(21) Appl. No.: 10/851,953

(22) Filed: May 21, 2004

(51) Int. Cl. A61H 7/00

(52) U.S. Cl. 601/136; 601/134

(57) ABSTRACT

An object of the present invention is to easily and inexpensively provide a therapeutic instrument that stimulates an acupuncture point and cures a malady without depending on a magnetic therapeutic instrument, needle therapy, moxa cautery or massage. The therapeutic instrument has a rod body which is provided at its central portion with a constriction, and at its upper and lower ends with flanges and having spreading portions respectively. The rod body is fitted into bases between adjacent fingers so as to push and stimulate the bases of the fingers to cure human body.

### BACKGROUND OF THE INVENTION

1) Field of the Invention

The present invention relates to a therapeutic instrument, and more particularly, to a therapeutic instrument having a rod body, wherein the rod body is provided at its central portion with a constriction, and at its upper and lower ends with flanges having spreading portions, respectively, and the rod body is fitted into bases between adjacent fingers so as to push and stimulate the bases of the fingers to cure human body.

2) Description of the Related Art

A magnetic therapeutic instrument is conventionally used for the same purpose. As an example, Patent Literature 1 (Japanese Patent Application Laid-Open No. H11-290465) discloses a court plaster type magnetic therapeutic instrument which is attached to an acupuncture point of human body to cure a malady. In this therapeutic instrument, a magnetic sheet which is alternately polarized with S-poles and N-poles is adhered to an adhering surface of an adherent sheet base material, and a sheet of peeling-paper is detachably adhered to the adhering surface such as to cover the magnetic sheet. According to this magnetic therapeutic instrument, the peeling-paper of the adherent sheet base material is removed, the magnetic sheet is adhered to an acupuncture point or a sore place of human body to promote health or reduce pain of that portion of the body.

Non-Patent Literature 2 (“Skin stimulating method, Acupuncture point and meridian (intermediate edition)” (see pages 6 to 8 “Acupuncture point and meridian” and others) issued by Acupuncture and moxocausis Development Association on Apr. 25, 1981) discloses another conventional technique. In this technique, skin is stimulated by needle therapy, moxa cautery or massage to act on an acupuncture point or meridian of human body to cure the body, thereby curing a malady.

### SUMMARY OF THE INVENTION

According to the conventional magnetic therapeutic instrument described in the patent literature 1, pain is eliminated through the magnetic sheet, the acupuncture point or the meridian is stimulated to cure the body. However, since the sheet must be adhered to the affected part every time, it is troublesome. Further, there are demerits that the magnetic sheet can be used only once and it can not be used repeatedly and thus it is uneconomical, other electronic parts and the like may be adversely affected by the magnet, and the magnetic material is expensive.

According to the conventional skin stimulating method described in the Non-Patent Literature 2, since the skin is stimulated, there are demerits that a special tool is required, it is necessary to rely on a professional, and cost thereof is expensive.

To stimulate an acupuncture point to smoothen a flow of meridian, and to cure a malady or the like, there is a technical problem to be solved to realize an inexpensive curing effect using a simple therapeutic instrument while eliminating inconvenience and diseconomy of the magnetic sheet adhesion and inconvenience of the magnet and without requiring special tool or professional. It is an object of the present invention to solve such a problem.

The present invention has been proposed to achieve the above object, and a first aspect of the invention provides a therapeutic instrument having a rod body, wherein the rod body is provided at its central portion with a constriction, and at its upper and lower ends with flanges having spreading portions, respectively, and the rod body is fitted into bases between adjacent fingers so as to push and stimulate the bases of the fingers to cure human body.

With this configuration, by fitting the rod body into bases between adjacent fingers, the bases of the fingers are pushed and stimulated thus stimulating the acupuncture points between thereof, and a meridian from the acupuncture point can be activated.

According to a second aspect of the invention, in the therapeutic instrument of the first aspect, the fingers are leg fingers, and the rod body is fitted into bases between adjacent leg fingers.

With this configuration, the rod body is fitted into bases between adjacent leg fingers. Thus, the rod body pushes and stimulates an acupuncture point of a finger base between the adjacent leg fingers on which nerves are concentrated. Therefore, a meridian from an acupuncture point near the finger base of the leg can be activated.

According to a third aspect of the invention, in the therapeutic instrument of the first aspect, the fingers are hand fingers, and the rod body is fitted into bases between adjacent hand fingers.

With this configuration, the rod body is fitted into bases between adjacent hand fingers. Thus, the rod body pushes and stimulates an acupuncture point of a finger base between the adjacent hand fingers on which nerves are concentrated. Therefore, a meridian from an acupuncture point near the finger base of the hand can be activated.

According to a fourth aspect of the invention, in the therapeutic instrument of any one of the first to third aspects, the rod body is made of soft material.

With this configuration, since the rod body is made of soft material, when the rod body made of soft material pushes the finger base, the rod body can come into soft contact with the base between the adjacent fingers and can appropriately be fitted into the base of the fingers.

The first aspect of the invention provides the therapeutic instrument having the rod body, wherein the rod body is provided at its central portion with the constriction, and at its upper and lower ends with flanges having spreading portions, respectively, and the rod body is fitted into bases between adjacent fingers so as to push and stimulate the bases of the fingers to cure human body. Since the rod body is provided at its central portion with the constriction, and at its upper and lower ends with flanges having spreading portions, and the rod body pushes and stimulates the acupuncture point existing near the finger base between the adjacent fingers, a meridian which is a path of a nerve from the acupuncture point is activated, the blood circulation is promoted, and numbness or stiffness of human body can be cured. Therefore, according to the first aspect of the invention, the therapeutic instrument is of a simple configuration and can easily be fitted into a fitting portion, and anyone can cure a malady using this therapeutic instrument at any time without spending much cost for needle therapy or massage.

According to the second aspect of the invention, in the therapeutic instrument of the first aspect, the fingers are leg fingers, and the rod body is fitted into bases between adjacent leg fingers. Thus, the rod body pushes and stimulates an acupuncture point of a finger base between the adjacent leg fingers on which many nerves related to cure of malady are concentrated. Therefore, a meridian from an acupuncture point of the leg can be activated. Therefore, if-the therapeutic instrument of the second aspect is used, it is possible to cure various maladies caused by inertness of meridian such as the leg.

According to the third aspect of the invention, in the therapeutic instrument of the first aspect, the fingers are hand fingers, and the rod body is fitted into bases between adjacent hand fingers. Apart from the leg, the rod body pushes and stimulates the acupuncture point near the finger base on which many nerves related to cure of malady are concentrated, and it is possible to activate meridian of such as a hand or upper-body from the acupuncture point. If the therapeutic instrument of the third aspect is used, it is possible to promote the blood circulation, and to cure the shoulder stiffness, numbness, and a malady caused by inertness of meridian of the arm or the upper-body.

According to the fourth aspect of the invention, in the therapeutic instrument of any one of the first to third aspects, the rod body is made of soft material. Therefore, in addition to the effects of the first, second, or third aspect, the rod body made of soft material comes into soft contact with the finger base. Thus, even if the rod body is fitted between the fingers, a user does not feel a sense of discomfort, and since the rod body softly fits into the finger base and maintains its shape, anyone can use the rod body appropriately.

### BRIEF DESCRIPTION OF THE DRAWINGS

FIG. 1(a) is a front view of a therapeutic instrument according to an embodiment of the present invention, and FIG. 1(b) is a plan view thereof;

FIG. 2 is a schematic plan view of the therapeutic instruments of the invention used for leg fingers (cross sections of central constrictions of the therapeutic instruments are shown) according to the embodiment; and

FIG. 3 is a schematic plan view of the therapeutic instruments of the invention used for hand fingers (cross sections of central constrictions of the therapeutic instruments are shown) according to the embodiment.

### DETAILED DESCRIPTIONS

The object of the invention to eliminate a malady such as shoulder stiffness or numbness without depending on a magnetic therapeutic instrument, needle therapy, moxa cautery or massage is achieved by fitting the rod body of the therapeutic instrument formed with the upper and lower flanges having spreading portions into the finger base between the adjacent fingers, and by pushing and stimulating the finger base using the rod body.

### First Embodiment

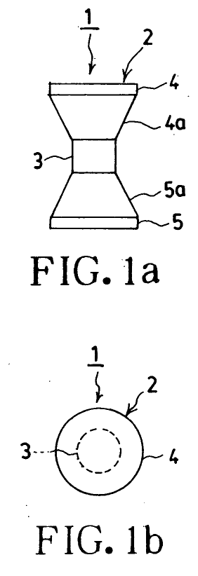

Embodiments of the present invention will be explained below with reference to FIGS. 1 to 3. FIG. 1 shows a therapeutic instrument 1 of the present invention. The therapeutic instrument 1 comprises a rod body 2 which is provided at its central portion with a constriction 3, and at its upper and lower portion with an upper end flange 4 and a lower end flange 5 through an upwardly and radially spreading portion 4a, which is upwardly and outwardly spreading toward the upper end flange 4 from the central constriction, and a downwardly and radially spreading portion 5a, which is downwardly and outwardly spreading toward the lower end flange 5 from the central constriction respectively. The upper and lower end flanges prevent the therapeutic instrument from coming off or jumping out from a gap between fingers. The central constriction 3 of the rod body 2 pushes bases of adjacent fingers, and the spreading portion 4a of the upper end flange and the spreading portion 5a of the lower end flange appropriately fit to the bases between the fingers to which the rod body is mounted, and an acupuncture point near the base of the fingers is appropriately stimulated. The rod body 2 needs to have a predetermined shape-retaining force, and the rod body 2 may be made of wood, metal, synthetic resin, paper, cloth, rubber and the like. When the rod body 2 of the present invention is made of synthetic resin, hard or soft synthetic resin may be selected, and the rod bodies can be mass-manufactured integrally by molding.

The same effect can be exerted by previously forming a hand mold or a leg mold and by forming the rod body between bases of the hand mold or the leg mold. The present invention can also be applied to a therapeutic instrument formed on the hand mold or the leg mold of course.

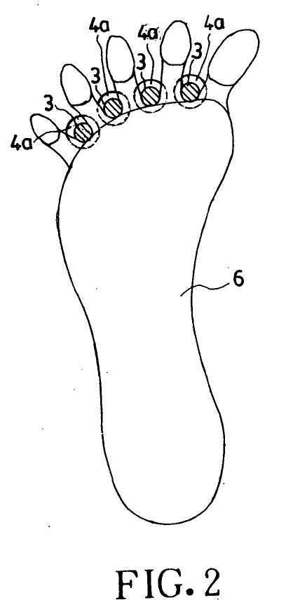

The therapeutic instrument 1 of the present invention used for fingers of a leg will be explained below with reference to FIG. 2. FIG. 2 shows a leg 6, and the therapeutic instruments 1 are used at four locations at bases between adjacent fingers of the leg 6. Since a distance between the adjacent fingers of the leg is narrow and five fingers are located side-by-side on one line at substantially equal distances from one another, the rod bodies of the therapeutic instruments are stably fitted between the fingers. Various nerve lines are concentrated on the leg and important acupuncture points also exist. Thus, if the acupuncture points of the leg are pushed and stimulated using the therapeutic instruments described in the second aspect, it is possible to activate various meridians from the acupuncture points of the leg and to cure various maladies caused by inertness of the meridians. The therapeutic instrument 1 can appropriately be fitted between any fingers, and it is not always necessary to use four therapeutic instruments.

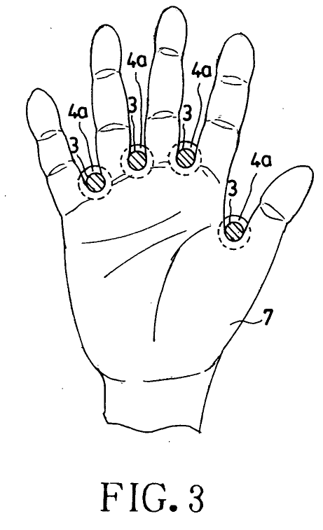

The therapeutic instruments 1 of the present invention used for fingers of a hand will be explained below with reference to FIG. 3. FIG. 3 shows a hand 7, and the therapeutic instruments 1 are used at four locations at bases between adjacent fingers of the hand. The central constrictions of the rod bodies push the finger bases between a little finger, a ring finger, between the ring finger and a middle finger, and between the middle finger and an index finger. The upper end flange spreading portions and the lower end flange spreading portions are appropriately fitted into the bases between the fingers. The same can be applied to between a thumb and the index finger, but if a distance between the thumb and the index finger is excessively long, causing inconvenience, retaining means such as rubber rings may be wound around the upper and lower end flanges of the therapeutic instrument so that the therapeutic instrument can be supported and locked by the thumb. Various nerve lines are also concentrated on the fingers of the hand, and important acupuncture points also exist near the finger bases of the hand. Thus, if such acupuncture points are pushed and stimulated using the rod body of the invention, it is possible to activate various meridians from the acupuncture points, and to activate the blood circulation of human body in the hand and the upper-body, and to eliminate malady such as shoulder stiffness and numbness. The therapeutic instrument 1 can appropriately be fitted between any adjacent fingers of a hand, and it is not always necessary to use four therapeutic instruments.

An embodiment in which the rod body 2 of the present invention is made of soft material will be explained. Rubber, synthetic rubber, expandable polyurethane resin, soft synthetic resin, air bag and the like are used as the soft material. If such a configuration is employed, the therapeutic instrument can come into contact with the base of fingers softly while the soft material maintains a predetermined shape. Therefore, the therapeutic instrument can appropriately fit into a base between fingers having any shape, and a user can use the therapeutic instrument without feeling a sense of discomfort. It is possible to prevent the therapeutic instrument from strongly pushing the base between the fingers where the instrument is fitted, and appropriate curing effect can be achieved. The therapeutic instruments comprising rod bodies can be connected to each other through a cord or a band. With this configuration, it is possible to prevent a user from losing the therapeutic instruments.

The present invention can variously be modified without departing from the sprit of the invention. Such modifications are also within the scope of this invention of course.

1. A therapeutic instrument having a rod body, wherein the rod body is provided at its central portion with a constriction, and at its upper and lower ends with flanges having spreading portions, respectively, and the rod body is fitted into bases between adjacent fingers so as to push and stimulate the bases of the fingers to cure human body.

2. The therapeutic instrument according to claim 1, wherein the fingers are leg fingers, and the rod body is fitted into bases between adjacent leg fingers.

3. The therapeutic instrument according to claim 1, wherein the fingers are hand fingers, and the rod body is fitted into bases between adjacent hand fingers.

4. The therapeutic instrument according to any one of claims 1 to 3, wherein the rod body is made of soft material.
